(19) United States
(12) Patent Application Publication
(10) Pub. No.: US 2021/0055878 A1
(43) Pub. Date: Feb. 25, 2021

(54) DATA COMPACTION WITHIN THE SAME PLANE OF A MEMORY COMPONENT

(71) Applicant: Micron Technology, Inc., Boise, ID (US)

(72) Inventors: Tomoko Ogura Iwasaki, San Jose, CA (US); Avani F. Trivedi, Eagle, ID (US); Aparna U. Limaye, Boise, ID (US); Jianmin Huang, San Carlos, CA (US); Tracy D. Evans, Boise, ID (US)

(21) Appl. No.: 16/947,794

(22) Filed: Aug. 17, 2020

Related U.S. Application Data
(60) Provisional application No. 62/889,237, filed on Aug. 20, 2019.

(51) Int. Cl. G06F 3/06; G06F 12/10; G06F 13/16

(52) U.S. Cl. CPC G06F 3/0647; G06F 3/0608; G06F 3/064; G06F 2212/1044; G06F 3/0673; G06F 12/10; G06F 13/1668; G06F 3/0652

(57) ABSTRACT

Systems, apparatuses, and methods related to data compaction in memory or storage systems or sub-systems, such as solid state drives, are described. For example, one or more memory pages storing valid data can be identified from a first data block in a plane of a memory component and copied to a page buffer corresponding to the plane. A controller of the system or sub-system can determine whether the plane of the memory component has another data block with capacity to store the one or more memory pages and can copy the one or more memory pages from the page buffer either to the other data block or to a different data block in a different plane of the memory component.

### RELATED APPLICATIONS

This application claims the benefit of U.S. Provisional Application No. 62/889,237, filed Aug. 20, 2019, the entire contents of which are hereby incorporated by reference herein.

### TECHNICAL FIELD

Embodiments of the disclosure relate generally to memory sub-systems, and more specifically, relate to data compaction within the same plane of a memory component.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data at the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a memory sub-system in accordance with some embodiments of the present disclosure.

FIG. 2 illustrates an example of data compaction at a memory component in accordance with some embodiments of the present disclosure.

FIG. 3 is a flow diagram of an example method to store data at a memory component of a memory sub-system using data compaction in accordance with some embodiments of the present disclosure.

FIG. 4 is a flow diagram of an example of storing data at a memory component of a memory sub-system using data compaction in accordance with some embodiments of the present disclosure.

FIG. 5 is a block diagram of an example computer system in which embodiments of the present disclosure can operate.

### DETAILED DESCRIPTION

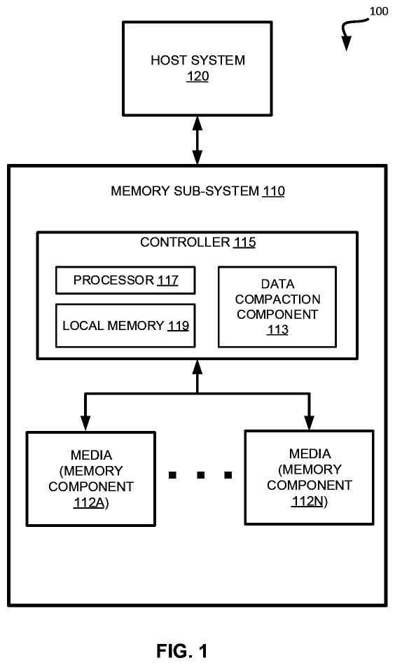

Aspects of the present disclosure are directed to managing a memory sub-system that includes data compaction within the same plane of memory component. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

The memory sub-system can include multiple memory components that can store data from the host system. Each memory component can include a different type of media. Examples of media include, but are not limited to, a cross-point array of non-volatile memory and flash based memory such as single-level cell (SLC) memory, triple-level cell (TLC) memory, and quad-level cell (QLC) memory. The characteristics of different types of media can be different from one media type to another media type. One example of a characteristic associated with a memory component is data density. Data density corresponds to an amount of data (e.g., bits of data) that can be stored per memory cell of a memory component. Using the example of a flash based memory, a quad-level cell (QLC) can store four bits of data while a single-level cell (SLC) can store one bit of data. Accordingly, a memory component including QLC memory cells will have a higher data density than a memory component including SLC memory cells. Another example of a characteristic of a memory component is access speed. The access speed corresponds to an amount of time for the memory component to access data stored at the memory component.

Other characteristics of a memory component can be associated with the endurance of the memory component to store data. When data is written to and/or erased from a memory cell of a memory component, the memory cell can be damaged. As the number of write operations and/or erase operations performed on a memory cell increases, the probability that the data stored at the memory cell including an error increases as the memory cell is increasingly damaged. A characteristic associated with the endurance of the memory component is the number of write operations or a number of program/erase operations performed on a memory cell of the memory component. If a threshold number of write operations performed on the memory cell is exceeded, then data can no longer be reliably stored at the memory cell as the data can include a large number of errors that cannot be corrected. Different media types can also have difference endurances for storing data. For example, a first media type can have a threshold of 1,000,000 write operations, while a second media type can have a threshold of 2,000,000 write operations. Accordingly, the endurance of the first media type to store data is less than the endurance of the second media type to store data.

Another characteristic associated with the endurance of a memory component to store data is the total bytes written to a memory cell of the memory component. Similar to the number of write operations, as new data is written to the same memory cell of the memory component the memory cell is damaged and the probability that data stored at the memory cell includes an error increases. If the number of total bytes written to the memory cell of the memory component exceeds a threshold number of total bytes, then the memory cell can no longer reliably store data.

A conventional memory sub-system can include memory components that are subject to memory management operations, such as garbage collection (GC), wear-leveling, folding, etc. Garbage collection seeks to reclaim memory occupied by stale or invalid data. Data can be written to the memory components in units called pages, which are made up of multiple cells. However, the memory can only be erased in larger units called blocks, which are made up of multiple pages. For example, a block can contain 64 pages. The size of a block can be 128 KB but can vary. If the data in some of the pages of the block is no longer needed (e.g., stale or invalid pages), then the block is a candidate for garbage collection. During the garbage collection process, the pages with good/valid data in the block are read and rewritten into another empty block. Then the original block can be erased, making all the pages of the original block available for new data.

The process of garbage collection involves reading and rewriting data to the memory component. This means that a new write from a host can entail a read of a whole block, a write of the valid pages within the block to another block, and then a write of the new data. The garbage collection processes being performed right before the write of new data can significantly reduce the performance of the system. Some memory sub-system controllers implement background garbage collection (BGC), sometimes called idle garbage collection or idle-time garbage collection (ITGC), where the controller uses idle time to consolidate blocks of the memory component before the host needs to write new data. This enables the performance of the device to remain high. If the controller were to background garbage collect all of the spare blocks before it was absolutely necessary, new data written from the host could be written without having to move any data in advance, letting the performance operate at its peak speed. The tradeoff is that some of those blocks of data are actually not needed by the host and will eventually be deleted, but the operating system (OS) did not convey this information to the controller. The result is that the soon-to-be-deleted data is rewritten to another location in the memory component, increasing the write amplification and negatively affecting the endurance of the memory component. Write amplification (WA) is an undesirable phenomenon associated with memory sub-systems, such as management memory, storage memory, solid-state drives (SSDs), etc., where the actual amount of information physically written to the storage media is a multiple of the logical amount intended to be written. In some memory sub-systems, the background garbage collection clears up only a small number of blocks then stops, thereby limiting the amount of excessive writes. Another solution is to have an efficient garbage collection system which can perform the necessary moves in parallel with the host writes. This solution is more effective in high write environments where the memory sub-system is rarely idle.

Conventional garbage collection consumes excessive power and time as traditional garbage collection does not necessarily read and write on the same plane. Reading data in one plane and writing the data to another plane is time-consuming, costly and inefficient. Furthermore, traditional garbage collection process can involve moving data off of the memory component unnecessarily.

Traditionally, during garbage collection, a controller moves valid data from a first block to second block. The controller searches for any available space in a block of the memory component to fold the valid data to without regard to whether that available space in the second block is on the same plane as the first block. So at times, the controller moves the data from one block on a first plane to another block on a second plane. When the controller folds data from the first plane to the second plane, the data traverses a data bus between the two planes. The travel time associated with traversing the data bus produces latency in the garbage collection operation, preventing the memory sub-system from being available to service host requests or perform other operations.

Aspects of the present disclosure address the above and other deficiencies by having a memory sub-system that performs data compaction within the same plane of a memory component. Such a memory sub-system can lower costs by reducing the resources needed for data compaction (e.g., SLC to TLC), data folding (e.g., TLC to TLC), and other forms of garbage collection by staying in the same plane, where possible, as opposed to using multiple planes. One of the benefits of the present disclosure is that during garbage collection, the controller verifies if there is any space for the data in a block that is in the first plane. If there is space in the first plane, the memory system benefits because the latency caused by the data bus travel time is avoided. If there is no space to fold the data in the same plane, then the controller can find a second block in a second plane. Embodiments of the present disclosure take advantage of any free space in the same plane before moving data to another plane during data folding.

FIG. 1 illustrates an example computing environment 100 that includes a memory sub-system 110 in accordance with some embodiments of the present disclosure. The memory sub-system 110 can include media, such as memory components 112A to 112N. The memory components 112A to 112N can be volatile memory components, non-volatile memory components, or a combination of such. In some embodiments, the memory sub-system is a storage system. An example of a storage system is a SSD. In some embodiments, the memory sub-system 110 is a hybrid memory/storage sub-system. In general, the computing environment 100 can include a host system 120 that uses the memory sub-system 110. For example, the host system 120 can write data to the memory sub-system 110 and read data from the memory sub-system 110.

The host system 120 can be a computing device such as a desktop computer, laptop computer, network server, mobile device, or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. As used herein, “coupled to” generally refers to a connection between components, which can be an indirect communicative connection or direct communicative connection (e.g., without intervening components), whether wired or wireless, including connections such as electrical, optical, magnetic, etc. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), etc. The physical host interface can be used to transmit data between the host system 120 and the memory sub-system 110. The host system 120 can further utilize an NVM Express (NVMe) interface to access the memory components 112A to 112N when the memory sub-system 110 is coupled with the host system 120 by the PCIe interface. The physical host interface can provide an interface for passing control, address, data, and other signals between the memory sub-system 110 and the host system 120.

The memory components 112A to 112N can include any combination of the different types of non-volatile memory components and/or volatile memory components. An example of non-volatile memory components includes a negative—and (NAND) type flash memory. Each of the memory components 112A to 112N can include one or more arrays of memory cells such as single level cells (SLCs) or multi-level cells (MLCs) (e.g., triple level cells (TLCs) or quad-level cells (QLCs)). In some embodiments, a particular memory component can include both an SLC portion and a MLC portion of memory cells. Each of the memory cells can store one or more bits of data (e.g., data blocks) used by the host system 120. Although non-volatile memory components such as NAND type flash memory are described, the memory components 112A to 112N can be based on any other type of memory such as a volatile memory. In some embodiments, the memory components 112A to 112N can be, but are not limited to, random access memory (RAM), read-only memory (ROM), dynamic random access memory (DRAM), synchronous dynamic random access memory (SDRAM), phase change memory (PCM), magneto random access memory (MRAM), negative—or (NOR) flash memory, electrically erasable programmable read-only memory (EEPROM), and a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. Furthermore, the memory cells of the memory components 112A to 112N can be grouped as memory pages or data blocks that can refer to a unit of the memory component used to store data.

The memory system controller 115 (hereinafter referred to as “controller”) can communicate with the memory components 112A to 112N to perform operations such as reading data, writing data, or erasing data at the memory components 112A to 112N and other such operations. The controller 115 can include hardware such as one or more integrated circuits and/or discrete components, a buffer memory, or a combination thereof. The controller 115 can be a microcontroller, special purpose logic circuitry (e.g., a field programmable gate array (FPGA), an application specific integrated circuit (ASIC), etc.), or other suitable processor. The controller 115 can include a processor (processing device) 117 configured to execute instructions stored in local memory 119. In the illustrated example, the local memory 119 of the controller 115 includes an embedded memory configured to store instructions for performing various processes, operations, logic flows, and routines that control operation of the memory sub-system 110, including handling communications between the memory sub-system 110 and the host system 120. In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the controller 115, in another embodiment of the present disclosure, a memory sub-system 110 may not include a controller 115, and can instead rely upon external control (e.g., provided by an external host, or by a processor or controller separate from the memory sub-system).

In general, the controller 115 can receive commands or operations from the host system 120 and can convert the commands or operations into instructions or appropriate commands to achieve the desired access to the memory components 112A to 112N. The controller 115 can be responsible for other operations such as wear leveling operations, garbage collection operations, error detection and error-correcting code (ECC) operations, encryption operations, caching operations, and address translations between a logical block address and a physical block address that are associated with the memory components 112A to 112N. The controller 115 can further include host interface circuitry to communicate with the host system 120 via the physical host interface. The host interface circuitry can convert the commands received from the host system into command instructions to access the memory components 112A to 112N as well as convert responses associated with the memory components 112A to 112N into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the controller 115 and decode the address to access the memory components 112A to 112N.

The memory sub-system 110 includes a data compaction component 113 that the controller 115 can use to compact data within the same plane of one or more of memory components 112A, 112N. In some embodiments, the controller 115 includes at least a portion of the data compaction component 113. For example, the controller 115 can include a processor 117 (processing device) configured to execute instructions stored in local memory 119 for performing the operations described herein. In some embodiments, the data compaction component 113 is part of the host system 120, an application, or an operating system.

If the data in some of the pages of a data block is no longer needed (e.g., stale or invalid pages), then the block is a candidate for garbage collection. The data compaction component 113 can identify a candidate data block within a plane for data compaction. The data compaction component 113 can copy valid data from the data block to a page buffer. The data compaction component 113 can copy the valid data from the page buffer to a block within the same plane and/or in another plane. Further details with regards to the operations of the data compaction component 113 are described below.

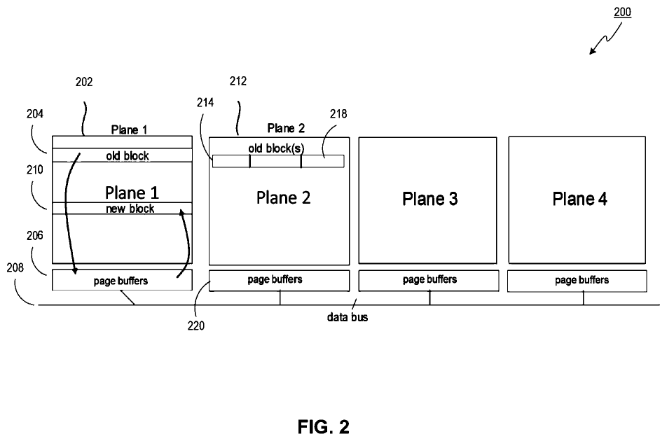

FIG. 2 is an example of data compaction at a memory component 200. Memory component 200 includes four planes: plane 1, plane 2, plane 3, and plane 4. Each plane has a corresponding page buffer and the planes are connected to each other by a data bus 208. The data bus 208 allows for communication and data transfer between the planes and the controller 115. The controller 115 executes various operations involving the planes by using the data bus 208. Each plane is divided into smaller sections called blocks (e.g., blocks 204, 210, 214). In some embodiments of the disclosure, the controller 115 can read and write to individual memory pages, but can erase on a block level.

Plane 1 202 includes a number of data blocks including old block 204 and new block 210, as well as any number of other data blocks. In this example, some data in the memory pages of data block 204 is no longer needed (e.g., stale or invalid pages), so the data compaction component 113 identifies data block 204 as a candidate for garbage collection. The data compaction component 113 can identify invalid pages in data block 204 by scanning the various memory components 112A-112N to identify one or more memory pages storing invalid/stale data. In some examples, the scanning can begin by identifying non-empty pages (e.g., memory cells in the page that include logical 0s). After identifying that a page is not empty, the data compaction component 113 can verify if the data is stale/invalid (e.g., not the most recent version of the data stored in the memory sub-system 110). A page containing data can be deemed invalid if the data is not at an up-to-date physical address of a corresponding logical address, if the data is no longer needed for the operation of a program, and/or if the data is corrupt in any other way. A page containing data can be deemed valid if the data is at an up-to-date physical address of a corresponding logical address, if the data is needed for the operation of a program, and/or if the data is not corrupt in any other way. Alternatively, the data compaction component 113 can identify the one or more memory pages storing valid data by referring to a record in the local memory 119.

Plane 1 202 can be selected for data compaction when the data compaction component 113 detects that plane 1 202 is beginning to run out of storage capacity to store new data and/or at least one block in plane 1 202 contains invalid data. When plane 1 202 is selected for data compaction, data compaction component 113 can copy the pages containing valid data from old block 204 to page buffers 206. Page buffers 206 are coupled to and correspond to plane 1 202. Page buffers 206 are also coupled to data bus 208. The pages containing valid data from old block 204 can be copied from page buffers 206 to new block 210 because data compaction component 113 detects that new block 210 has the storage capacity to store the incoming data. The data compaction component 113 can identify the free storage capacity of a block by scanning the blocks in plane 1, plane 2, plane 3, and plane 4 to identify empty pages (e.g., memory cells in the page that include logical 1s) or referring to a record in the local memory 119. New block 210 can be deemed as having storage capacity when it has enough space to store some of the valid data from old block 204. In some embodiments, a portion of the valid data from old block 204 can be stored in new block 210 and another portion of the valid data from old block 204 can be stored in one or more other blocks with storage capacity. When a block has storage capacity, the data compaction component 113 can identify the block as a target block for storing valid data from another block whose data is to be compacted.

A time-saving and cost-effective aspect of these examples is the fact that old block 204 and new block 210 are in the same plane, namely plane 1 202. Accordingly, the pages containing valid data from old block 204 do not have to go through the data bus 206 to reach a different plane (e.g., plane 2 212, plane 3, or plane 4).

In one example, the controller 115 or data compaction component 113 can compact the valid data from old block 204 back into old block 204 (e.g. the valid data from old block 204 is copied to page buffers 206, old block 204 is erased, and the valid data from page buffers 206 is copied back to old block 204). In such case, the side effects of write amplification, wherein elements of the memory component (e.g., blocks) can be programmed and erased only a limited number of times, can be accounted for by the memory sub-system 110 by using various techniques, such as wear leveling. Write amplification is often referred to as the maximum number of program/erase cycles (P/E cycles) a memory component 112N can sustain over its lifetime. Nominally, each NAND block can survive 100,000 P/E cycles. Wear leveling can ensure that all physical blocks are exercised uniformly. The controller 115 can use wear leveling to ensure uniform programming and erasing in any of the examples in the present disclosure. The host system 120, the memory sub-system 110, data compaction component 113, and/or controller 115 can keep record of the amount of times a block has been programmed (e.g. written to) and erased in order not to wear out any given memory component 112A-112N.

In some examples, valid data can be transferred from the old block 204 to the corresponding page buffers 206 and from the page buffers 206 to the new block 210 in segments of memory page by memory page. In other examples, valid data can be transferred from the old block 204 to the corresponding page buffers 206 and from the page buffers 206 to the new block 210 in segments that are smaller than a memory page. For example, the valid data from old block 204 can be copied to corresponding page buffers 206 in piecemeal fashion, wherein segments of valid data smaller than the size of one memory page are copied to page buffers 206. Piecemeal data transfer can be more efficient than copying data in memory page-sized chunks because piecemeal chunks of data are faster to move. A piecemeal chunk of data can be 2 KB, 4 KB, 6 KB, 8 KB or any other size. This piecemeal data transfer can be referred to as partial-page programming.

Due to the large size of memory pages, partial-page programming is useful for storing smaller amounts of data. In some examples, each 2112 byte memory page can accommodate four PC-sized, 512-byte sectors. The spare 64 byte area of each page can provide additional storage for error-correcting code (ECC). While it can be advantageous to write all four sectors at once, often this is not possible. For example, when data is appended to a file, the file might start out as 512 bytes, then grow to 1024 bytes. In this situation, a first program page operation can be used to write the first 512 bytes to the memory sub-system 110 and a second program page operation can be used to write the second 512 bytes to the memory sub-system 110. In some examples, the maximum number of times a partial page can be programmed before an erase is required is four times. In some examples using MLC memory sub-systems, only one partial-page program per page can be supported between erase operations.

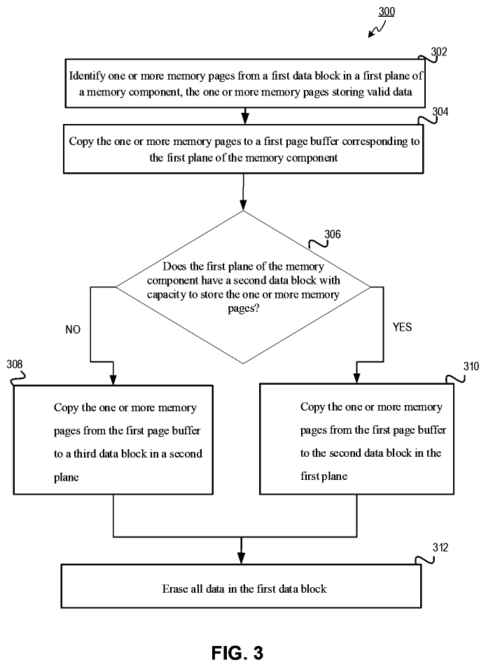

FIG. 3 is a flow diagram of an example method 300 to compact data within the same plane of a memory component. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the data compaction component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 302, the processing device can identify one or more memory pages from a first data block 204 in a first plane 202 of a memory component 112A, 112N, the one or more memory pages storing valid data. The processing device can use the data compaction component 113 to identify the one or more memory pages storing valid data from the first data block 204 in the first plane 202 of the memory component 112A, 112N. The data compaction component 113 can scan the various memory components 112A-112N to identify one or more memory pages storing valid data. In some examples, the data compaction component 113 can scan and identify non-empty pages (e.g., memory cells of the page include logical 0s). After identifying that a page is not empty, the data compaction component 113 can verify if the data is still valid. A page containing data can be deemed valid if the data is at an up-to-date physical address of a corresponding logical address, if the data is needed for a program, and/or if the data is not corrupt in any other way. Alternatively, the data compaction component 113 can identify the one or more memory pages storing valid data by referring to a record in the local memory 119. When the data compaction component 113 determines that the free space to store valid data is starting to run out in one of the memory components 112A-112N, the controller 115 can trigger the data compaction component 113 to commence the data compaction sequence disclosed herein.

At block 304, the processing device can copy the one or more memory pages to a first page buffer 206 corresponding to the first plane 202 of the memory component 112A, 112N. Copying a memory page can include a page read operation. A page read operation can take around 25 μs, during which the page is accessed from a memory cell array and loaded into the page buffer 206. The page buffer 206 can be a 16,896-bit (2112-byte) register. The processing device may then access the data in the page buffer 206 to write the data to a new location (e.g., new block 210). Copying a memory page can also include a write operation, wherein the processing device can write the data to the new block 210 at various rates (e.g., 7 MB/s or faster).

At block 306, the processing device can determine whether the first plane 202 of the memory component has a second data block 210 with capacity to store the one or more memory pages. The processing device can use the data compaction component 113 to determine whether the first plane 202 of the memory component 112A, 121N has a second data block 210 with capacity to store the one or more memory pages. The data compaction component 113 can scan various memory components 112A-112N to identify one or more memory pages with storage capacity for new data. Memory pages with storage capacity can be referred to as “free memory pages.” Alternatively, the data compaction component 113 can identify the one or more free memory pages by referring to a record in the local memory 119.

If the second data block 210 has the capacity to store the one or more memory pages, then at block 308 the processing device can proceed to copy the one or more memory pages from the first page buffer 206 to the second data block 210 in the first plane 202. The copying can comprise reading the one or more memory pages from the first page buffer 206 and writing the one or more memory pages to the second data block 210. In some examples, it can take the processing device 220 μs to 600 μs to write one page of data. At block 308, the processing device does not need to use the data bus 208 to transport the one or more memory pages from the first page buffer 206 to the second data block 210 because the second data block 210 is in the same plane 202 and the first data block 204. Because the data bus travel is avoided in this data transfer sequence, the latency associated with moving data along the data bus is also avoided. Accordingly, the operating efficiency of the memory sub-system 110 is improved.

If the second data block 210 does not have the capacity to store the one or more memory pages, then at block 310 the processing device can proceed to copy the one or more memory pages from the first page buffer 206 to a third data block 214 in a second plane 212. Because the third data block 214 is in a different plane than the first data block, the one or more memory pages travel on the data bus in order to reach the second plane 212. This travel time affects the operating speed and available bandwidth of the data bus 208 and memory sub-system 110. In other examples, the processing device can also copy the one or more memory pages from the first page buffer 206 to one memory page 218 from the second data block 214 (e.g., SLC to TLC compaction, wherein three SLC pages can be written into one TLC page; and TLC to TLC folding). The processing device can also copy the one or more memory pages from the first data block 204 to the first page buffer 206 in piecemeal quantities that are smaller than the size of one memory page (e.g., 0.5 KB, 1 KB, 2 KB, 3 KB, or 4 KB pieces).

At block 312, the processing device can erase all data in the first data block 204, thus freeing up the first data block completely to be written to. In some examples, the processing device can effectuate the erase procedure by setting the memory cells in the block to logical 1. In some examples, the processing device can take up to 500 μs to complete the erasing.

Method 300 can include a read for internal data move command. A read for internal data move command can also be known as “copy back.” It provides the ability to move data internally from one page to another—the data never leaves the memory sub-system 110. The read for internal data move operation transfers the data read from the one or more memory pages to a page buffer (e.g., page buffer 206). The data can then be programmed/written into another page of the memory sub-system 110 (e.g., at second block 210). This is extremely beneficial in cases where the controller 115 needs to move data out of a block 204 before erasing the block 204 (e.g. data compaction). It is also possible to modify the data read before the program operation is started. This is useful if the controller 115 wants to change the data prior to programming.

The processing device can further perform an error detection and correction on and/or off the memory component. Error-correcting code memory (ECC memory) can be used in this process. ECC memory is a type of computer data storage that can detect and correct the most common kinds of internal data corruption. ECC memory can maintain a memory system immune to single-bit errors: the data that is read from each word is always the same as the data that had been written to it, even if one of the bits actually stored has been flipped to the wrong state.

ECC can also refer to a method of detecting and then correcting single-bit memory errors. A single-bit memory error can be a data error in server/system/host output or production, and the presence of errors can have a big impact on server/system/host performance. There are two types of single-bit memory errors: hard errors and soft errors. Hard errors are caused by physical factors, such as excessive temperature variation, voltage stress, or physical stress brought upon the memory bits. Soft errors occur when data is written or read differently than originally intended, such as variations in voltage on the motherboard, to cosmic rays or radioactive decay that can cause bits in the memory to flip. Since bits retain their programmed value in the form of an electrical charge, this type of interference can alter the charge of the memory bit, causing an error. In servers, there are multiple places where errors can occur: in the storage drive, in the CPU core, through a network connection, and in various types of memory. Error detection and correction can mitigate the effect of these errors.

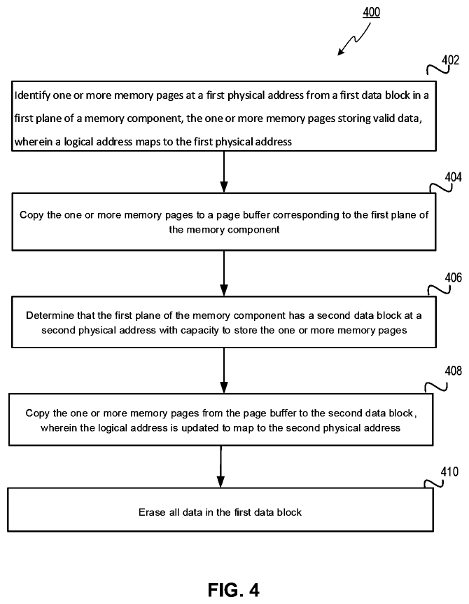

FIG. 4 is a flow diagram of an example method 400 to compact data within the same plane 202 of a memory component. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the data compaction component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 402, the processing device can identify one or more memory pages at one or more first physical addresses from a first data block 204 in a first plane 202 of a memory component 112A, 112N, the one or more memory pages storing valid data, wherein a logical address maps to the first physical address. A logical address can be generated by a central processing unit (CPU), which is included in or works in conjunction with the host system 120 or memory sub-system 110. The logical address is virtual address as it does not exist physically. This virtual address is used as a reference to access the physical memory location by the CPU. The term logical address space can be used for the set of all logical addresses generated from a program's perspective. The host system 120 can include or work in conjunction with a hardware device called a memory-management unit (MMU) that maps the logical address to its corresponding physical address. The physical address identifies a physical location of data in the memory component 112A, 112N. The host system 120 does not deal with the physical address but can access the physical address by using its corresponding logical address. A program generates the logical address but the program needs physical memory for its execution, therefore the logical address is mapped to the physical address by the MMU before it is used. The term physical address space is used for all physical addresses corresponding to the logical addresses in a logical address space. A relocation register can be used to map the logical address to the physical address in various ways. In some examples, when the CPU generates a logical address (e.g., 345), the MMU can generate a relocation register (e.g., 300) that is added to the logical address to identify the location of the physical address (e.g., 345+300=645). In the present disclosure, when valid data is moved from one block to another, the relocation register can be updated to reflect the new location of the valid data.

At block 402, the processing device can use the data compaction component 113 to identify the one or more memory pages storing valid data from the first data block 204 in the first plane 202 of the memory component 112A, 112N. The data compaction component 113 can scan the various memory components 112A-112N to identify one or more memory pages storing valid data. In some examples, the data compaction component 113 can scan and identify non-empty pages (e.g., memory cells of the page include logical 0s). After identifying that a page is not empty, the data compaction component 113 can verify if the data is still valid. A page containing data can be deemed valid if the data is at the up-to-date physical address of a corresponding logical address, if the data is still needed by a program, and/or if the data is not corrupt in any other way. Alternatively, the data compaction component 113 can identify the one or more memory pages storing valid data by referring to a record in the local memory 119. When the controller 115 determines that free space to store valid data is starting to run out in one of the memory components 112A-112N, the controller 115 can trigger the data compaction component 113 to commence a data compaction sequence.

At block 404, the processing device can copy the one or more memory pages to a page buffer 206 corresponding to the first plane 202 of the memory component. Copying a memory page can include a page read operation. A page read operation can take around 25 μs, during which the page is accessed from a memory cell array and loaded into the page buffer 206. The page buffer 206 can be a 16,896-bit (2112-byte) register. The processing device may then access the data in the page buffer 206 to write the data to a new location. Copying a memory page can also include a write operation, wherein the processing device can write the data to the new block 210 at various rates (e.g., 7 MB/s or faster).

At block 406, the processing device can determine that the first plane 202 of the memory component has a second data block 210 at a second physical address with capacity to store the one or more memory pages. The processing device can use the data compaction component 113 to determine that the first plane 202 of the memory component has a second data block 210 with capacity to store the one or more memory pages. The data compaction component 113 can scan various memory components 112A-112N to identify one or more memory pages with storage capacity for new data. Memory pages with storage capacity can be referred to as “free memory pages.” Alternatively, the data compaction component 113 can identify the one or more free memory pages by referring to a record in the local memory 119.

At block 408, the processing device can copy the one or more memory pages from the page buffer 206 to the second data block 210, wherein the logical address is updated to map to the second physical address. The copying can comprise writing the one or more memory pages to the second data block 210. In some examples, it can take the processing device 220 μs to 600 μs to write one page of data. At block 308, the processing device does not need to use the data bus 208 to transport the one or more memory pages from the first page buffer 206 to the second data block 210 because the second data block 210 is in the same plane 202 and the first data block 204. Because unnecessary data bus travel is avoided in this data transfer sequence, the latency associated with moving data along the data bus is also avoided. Accordingly, the operating efficiency of the memory sub-system 110 is improved.

At block 410, the processing device can erase all data in the first data block 204, thus freeing up the first data block 204 completely to be written to or programmed. In some examples, the processing device can effectuate the erase procedure by setting the memory cells in the block to logical 1. In some examples, the processing device can take up to 500 μs to complete the erasing.

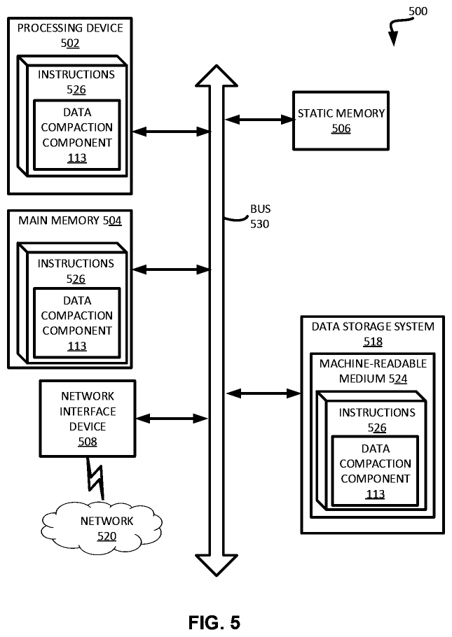

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the data compaction component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to a data compaction component (e.g., the data compaction component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
identifying one or more memory pages from a first data block in a first plane of a memory component, the one or more memory pages storing valid data;
copying the one or more memory pages to a first page buffer corresponding to the first plane of the memory component;
determining whether the first plane of the memory component has a second data block with capacity to store the one or more memory pages; and at least one of:
responsive to the second data block having the capacity, copying the one or more memory pages from the first page buffer to the second data block; or
responsive to the second data block lacking the capacity, copying the one or more memory pages storing valid data from the first data buffer to a third data block in a second plane of the memory component.

2. The method of claim 1, wherein the memory component comprises a plurality of planes, the plurality of planes comprising the first plane and the second plane.

3. The method of claim 2, wherein each plane of the plurality of planes has a respective associated page buffer.

4. The method of claim 1, further comprising:
transferring the one or more memory pages storing valid data via a data bus.

5. The method of claim 1, wherein the one or more memory pages are copied to one memory page from the second data block.

6. The method of claim 1, wherein the one or more memory pages are copied to the first page buffer in piecemeal quantities that are smaller than a size of one memory page within the one or more memory pages.

7. The method of claim 1, further comprising:
erasing all data in the first data block.

8. A system comprising:
a memory component; and
a processing device, coupled to the memory component, to:
identify one or more memory pages from a first data block in a first plane of a memory component, the one or more memory pages storing valid data;
copy the one or more memory pages to a first page buffer corresponding to the first plane of the memory component;
determine whether the first plane of the memory component has a second data block with capacity to store the one or more memory pages; and at least one of:
responsive to the second data block having the capacity, copy the one or more memory pages from the first page buffer to the second data block; or
responsive to the second data block lacking the capacity, copy the one or more memory pages storing valid data from the first data buffer to a third data block in a second plane of the memory component.

9. The system of claim 8, wherein the memory component comprises a plurality of planes, the plurality of planes comprising the first plane and the second plane.

10. The system of claim 9, wherein each plane of the plurality of planes has a respective associated page buffer.

11. The system of claim 8, wherein the processing device is further to transfer the one or more memory pages storing valid data via a data bus.

12. The system of claim 8, wherein the processing device copies the one or more memory pages storing valid data from the first page buffer to one memory page from the second data block.

13. The system of claim 8, wherein the processing device copies the one or more memory pages from the first data block to the first page buffer in piecemeal quantities that are smaller than a size of one memory page within the one or more memory pages.

14. The system of claim 8, wherein the processing device is further to perform an error detection and correction on or off the memory component.

15. A non-transitory computer-readable storage medium comprising instructions that, when executed by a processing device, cause the processing device to:
identify one or more memory pages at a first physical address from a first data block in a first plane of a memory component, the one or more memory pages storing valid data, wherein a logical address maps to the first physical address;
copy the one or more memory pages to a page buffer corresponding to the first plane of the memory component;
determine whether the first plane of the memory component has a second data block at a second physical address with capacity to store the one or more memory pages; and at least one of:
responsive to the second data block having the capacity, copy the one or more memory pages from the page buffer to the second data block, wherein the logical address is updated to map to the second physical address; or
responsive to the second data block lacking the capacity, copy the one or more memory pages storing valid data from the first data buffer to a third data block in a second plane of the memory component.

16. The non-transitory computer-readable storage medium of claim 15, wherein the memory component comprises a plurality of planes, the plurality of planes comprising the first plane and the second plane.

17. The non-transitory computer-readable storage medium of claim 16, wherein each plane of the plurality of planes has a respective associated page buffer.

18. The non-transitory computer-readable storage medium of claim 15, wherein the processing device is further to transfer the one or more memory pages storing valid data via a data bus.

19. The non-transitory computer-readable storage medium of claim 15, wherein the processing device copies the one or more memory pages storing valid data from the first page buffer to one memory page from the second data block.

20. The non-transitory computer-readable storage medium of claim 15, wherein the processing device copies the one or more memory pages from the first data block to the first page buffer in piecemeal quantities that are smaller than a size of one memory page within the one or more memory pages.
